(19) United States
(12) Patent Application Publication
(10) Pub. No.: US 2022/0232872 A1
(43) Pub. Date: Jul. 28, 2022

(54) NATURAL COMPOSITE MATERIALS DERIVED FROM SEAWEED AND METHODS OF MAKING THE SAME

(71) Applicant: HEALTHALL LABORATORY, INC., Pasadena, CA (US)

(72) Inventor: Lijun SUN, La Canada Flintridge, CA (US)

(21) Appl. No.: 17/620,031

(22) PCT Filed: Jun. 19, 2020
(86) PCT No.: PCT/US2020/070161

§ 371 Date: Dec. 16, 2021

Related U.S. Application Data
(60) Provisional application No. 62/865,061, filed on Jun. 21, 2019.

(51) Int. Cl. A23L 29/256; A23L 17/60; A23P 10/22

(52) U.S. Cl. CPC A23L 29/256; A23V 2002/00; A23P 10/22; A23L 17/60

(57) ABSTRACT

Provided are natural seaweed composite materials comprising one or more insoluble fibers and carrageenan associated with the insoluble fiber. The natural seaweed composite materials are produced by methods comprising high pressure homogenization which maintains the natural complex structure of the insoluble fiber and the carrageenan as in natural unprocessed seaweeds.

### CROSS-REFERENCE TO RELATED APPLICATIONS

This application claims the benefit of U.S. Provisional Patent Application No. 62/865,061, filed Jun. 21, 2019, which is incorporated herein by reference in its entirety.

### TECHNICAL FIELD

This disclosure relates to natural composite materials derived from seaweed and methods of making the same. The natural composite material disclosed herein comprises carrageenan and insoluble fiber, and the natural composite material may have different structural features depending on the manufacturing processes.

### BACKGROUND

Carrageenans are a class of water-soluble polysaccharides extracted from certain species of red algae, including Kappaphycus alvarezii and Eucheuma denticulatum. Carrageenans have broad applications in food industry due to their gelling, thickening, and stabilizing properties. Carrageenans have a unique property of binding and stabilizing proteins, as such, carrageenans are widely used in dairy and meat products. The traditional approach of extracting carrageenans from seaweeds requires hot alkali treatment, which may break down carrageenans and other valuable nutrients in the seaweeds. The traditional process also causes a waste of the raw materials by discarding insoluble fibers such as cellulose in the seaweeds. Therefore, there is a need in the field to fully develop and use seaweeds for natural composite materials, particularly high quality natural composite materials suitable for food applications.

### SUMMARY

In one aspect, provided herein are natural seaweed composite materials having different structural and functional features. The natural seaweed composite materials are obtained from red algae and comprise one or more insoluble fibers such as cellulose and insoluble hemicellulose and carrageenan. In some embodiments, the natural seaweed composite material is obtained from carrageenophyte red algae. In some embodiments, the carrageenan is associated with the insoluble fiber, and the association between the carrageenan and the insoluble fiber is substantially the same as the association between the carrageenan and the insoluble fiber in natural seaweed before being processed. In some embodiments, the carrageenan is bound to the surface of the insoluble fiber such as cellulose of the natural seaweed composite material. In some embodiments, the insoluble fiber is partially or entirely encapsulated by carrageenan. In some embodiments, the insoluble fiber is entirely or partially embedded within carrageenan. In some embodiments, the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm. In some embodiments, the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.

In some other embodiments, the natural seaweed composite material is highly absorbent and comprises one or more insoluble fibers and carrageenan, wherein the insoluble fiber is capable of self-assembly into a highly ordered structure such that the cellulose fibers align along the same direction during the gelling and drying process, and upon rehydration, the fiber assembly rapidly expands into an ordered array wherein the fiber fragments are dispersed but arranged parallelly along the fiber axis. This unusual property can have useful applications in food engineering.

In another aspect, provided herein is a method of making a natural seaweed composite material from red algae. The method comprises the steps of pretreating the fresh or dried seaweed with a salt such as potassium chloride (KCl) at a high concentration under heat such as at 80-100° C., subjecting the pretreated seaweed to high pressure homogenization (HPH), and drying and grinding the homogenized seaweed to a desired particle size to obtain the natural seaweed composite material. In some embodiments, the seaweed is ground by wet milling or dry grinding before or after the salt treatment. In some embodiments, the HPH is carried out at a temperature of between 0° C. and 85° C., e.g., between 0° C. and 50° C., between 20° C. and 40° C., between 25° C. and 30° C., or at room temperature. In some embodiments, the HPH is carried out at a temperature of between 60° C. and 100° C. The obtained natural seaweed composite material has a gelling strength in the range of 200-1000 g/cm² depending on the starting seaweed materials and manufacturing processes. In some embodiments, the seaweed is washed and/or cleaned to remove debris before grinding or the salt treatment. In some embodiments, the seaweed is bleached by one or more bleaching agents before HPH.

In a related aspect, provided herein is a natural seaweed composite material produced by any of the methods disclosed above. The natural seaweed composite material comprises one or more insoluble fibers such as cellulose and insoluble hemicelluloses and carrageenan, wherein the carrageenan is associated with the insoluble fiber when the HPH step is carried out at a temperature of between 0° C. and 85° C., e.g., between 0° C. and 50° C., between 20° C. and 40° C., between 25° C. and 30° C., or at room temperature. In some embodiments, the insoluble fiber is associated with carrageenan in a manner similar to the association in the natural state in seaweed before processing. In some embodiments, the carrageenan is bound to the surface of the insoluble fiber such as cellulose of the natural seaweed composite material. In some embodiments, the insoluble fiber is entirely or partially embedded within carrageenan. In some embodiments, the insoluble fiber is partially or entirely encapsulated by carrageenan. In some embodiments, the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm. In some embodiments, the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.

In some other embodiments, the natural seaweed composite material produced by the method in which the HPH step is carried out at a temperature of between 60° C. and 100° C. is highly absorbent and comprises one or more insoluble fibers and carrageenan, wherein the insoluble fiber is capable of self-assembly into a highly ordered structure such that the cellulose fibers align along the same direction during the gelling and drying process, and upon rehydration, the fiber assembly rapidly expands into an ordered array wherein the fiber fragments are dispersed but arranged parallelly along the fiber axis.

### BRIEF DESCRIPTION OF THE DRAWINGS

This application contains at least one drawing executed in color. Copies of this application with color drawing(s) will be provided by the Office upon request and payment of the necessary fees.

FIG. 1 shows the results of the stability test of the seaweed composite materials and the control (Sample B shown in diamonds, Sample L shown in squares, and Sample M shown in triangles).

FIGS. 2A-2C show an imaging analysis of Sample L, with a view of a larger ensemble of particles (FIG. 2A), a view of more spread-out particles (FIG. 2B), and a zoomed-in view of a few particles showing the insoluble fiber (arrow-pointed brighter colored region) and carrageenan (arrow-pointed opaque region) in the natural composite material.

FIGS. 3A-3C show an imaging analysis of Sample B, with a view of a larger ensemble of particles (FIG. 3A), a view of more spread-out particles (FIG. 3B), and a zoomed-in view of a few particles showing the insoluble fiber (arrow-pointed brighter colored region) and carrageenan (arrow-pointed opaque region) in the natural composite material.

FIG. 4 shows comparative imaging analysis of different seaweed composite material samples by light microscope.

FIGS. 5A-5B show the comparative imaging analysis of the cellulose fiber structure in Sample M. FIG. 5A: 1% (w/w) of Sample M in deionized water was boiled for 5 minutes to melt carrageenan before imaging. FIG. 5B: 1% (w/w) of Sample M in deionized water was boiled for 5 minutes to melt carrageenan, 0.2% KCl was added, and then cooled to room temperature to form a gel before imaging. Images were taken with a Leica light microscope equipped with polarized filter (model MZ125). At a certain polarization angle, the crystalline cellulose fiber showed in bright color.

FIGS. 6A-6C show the comparative imaging analysis of the cellulose fiber structure in Sample L. FIG. 6A: 1% (w/w) of Sample L in deionized water without boiling before imaging. FIG. 6B: 1% (w/w) of Sample L in deionized water was boiled for 5 minutes to melt carrageenan before imaging. FIG. 6C: 1% (w/w) of Sample L in deionized water was boiled for 5 minutes to melt carrageenan, 0.2% KCl was added, and then cooled to room temperature to form a gel before imaging. Images were taken with a Leica light microscope equipped with polarized filter (model MZ125). At a certain polarization angle, the crystalline cellulose fiber will show bright color.

FIGS. 7A-7C show the comparative imaging analysis of the cellulose fiber structure in Sample B. FIG. 7A: 1% (w/w) of Sample B in deionized water without boiling before imaging. FIG. 7B: 1% (w/w) of Sample B in deionized water was boiled for 5 minutes to melt carrageenan before imaging. FIG. 7C: 1% (w/w) of Sample B in deionized water was boiled for 5 minutes to melt carrageenan, 0.2% KCl was added, and then cooled to room temperature to form a gel before imaging. Images were taken with a Leica light microscope equipped with polarized filter (model MZ125). At a certain polarization angle, the crystalline cellulose fiber will show bright color.

FIG. 8 shows particle size analysis of the insoluble fiber in Sample B.

### DETAILED DESCRIPTION

Seaweed may contain up to 75% of its dry weight dietary fiber, of which up to 85% could be water soluble fiber. Within this range, the total weight fraction of dietary fiber and the ratio between soluble and insoluble fiber vary depending on the specific seaweed species and growing conditions. In carrageenophyte red seaweed, the main soluble fiber is carrageenan while the main insoluble fiber is cellulose and insoluble hemicelluloses with residual amount of other insoluble polysaccharides.

Natural seaweed composite materials and methods for making such natural seaweed composite materials are provided herein. The methods result in natural seaweed composite materials in which the natural association between the insoluble fiber and carrageenan is maintained without any substantial dissociation of the carrageenan from the insoluble fiber when the manufacturing process is carried out at a temperature lower than or about 85° C. (e.g. at 10° C., 30° C., 50° C. or room temperature). The obtained natural seaweed composite material comprises one or more insoluble fibers and carrageenan associated with the insoluble fiber. In some embodiments, the structure of the insoluble fiber is disrupted without melting or dissociating the carrageenan from the insoluble fiber. As used herein, “disruption” of the insoluble fiber means that the densely packed or “bundled” structure of the insoluble fiber in its natural state in unprocessed seaweed is changed into a loose or disorganized structure after the seaweed being subjected to the process steps disclosed herein, resulting the natural seaweed composite material wherein the structural modified algae insoluble fiber remains bound by carrageenan. Alternatively, when the manufacturing process is carried out at a temperature higher than 60° C. such as 60° C.-100° C., the methods result in a highly absorbent natural seaweed composite material in which the insoluble fiber is capable of self-assembly into a highly ordered structure wherein the cellulose fibers align along the same direction during the gelling and drying process, and upon rehydration, the fiber assembly can rapidly expand into an ordered array wherein the fiber fragments are dispersed but arranged parallelly along the fiber axis. This unusual property can have useful applications in food engineering using naturally available materials.

As used herein, “associated” or “association” means that the carrageenan is bound to the surface of the insoluble fiber, the insoluble fiber is partially or entirely encapsulated by the carrageenan, or the insoluble fiber is partially or entirely embedded within the carrageenan. In some embodiments, the insoluble fiber forms a “bundled” fiber core, with the carrageenan bound to the surface of the insoluble fiber core in the natural seaweed composite material.

The terms “seaweed,” “algae” and “marine algae” may be used interchangeably in this disclosure to mean marine plants or macroalgae and include red algae, brown algae, and green algae.

### I. Composition of the Natural Seaweed Composite Material

Carrageenans are high-molecular-weight polysaccharides made up of repeating galactose units and 3,6 anhydrogalactose (3,6-AG), both sulfated and nonsulfated. The units are joined by alternating α-1,3 and β-1,4 glycosidic linkages. Naturally existing carrageenans have a polydispersive molecular weight distribution between 200,000 and 800,000 Da with less than 5% below 50,000 Da or less than 0.5% below 20,000 Da. The molecular weight distribution may vary depending on the source and growth stage of the seaweed used for carrageenan extraction. The low molecular weight fraction of natural carrageenan is the product of incomplete natural biosynthesis of carrageenan by seaweed during the normal life cycle before harvesting. These natural low molecular weight carrageenans are believed to be fundamentally different from the degraded carrageenan or poligeenan produced by strong chemical reactions such as treating with concentrated acids under heat. The low molecular weight degraded carrageenan or poligeenan have raised some health concerns. Thus, a process to avoid or minimize chemical exposure of natural carrageenan is highly desirable. Carrageenans are further classified by the degree of sulfation in the polysaccharide polymer. Kappa-carrageenan has one sulfate group per disaccharide, iota-carrageenan has two, and lambda-carrageenan has three. Kappa-carrageenan forms strong, rigid gels in the presence of potassium ions, and reacts with dairy proteins. It is extracted mainly from Kappaphycus alvarezii. Iota-carrageenan forms soft gels in the presence of calcium ions. It is produced mainly from Eucheuma denticulatum. Lambda-carrageenan does not gel, and therefore, is used to thicken dairy products. Lambda-carrageenan can be extracted from many different species.

The most commonly used raw seaweeds for making carrageenans are Kappaphycus alvarezii and Eucheuma denticulatum, which account for three-quarters of the world production of carrageenans. The typical carrageenan extraction process involves treating the seaweed raw materials with hot alkali solution (e.g., 5-8% potassium hydroxide) to dissolve and separate carrageenan from the seaweed matrix, and then the cellulose in the seaweed cell wall is removed from the carrageenan by centrifugation and filtration. The resulting carrageenan solution is then concentrated by evaporation, and dried and ground to desired particle sizes.

The conventional carrageenan extraction processes can be classified as semi-refined, refined and mixed processes. In the semi-refined process, the raw seaweed is cleaned and cooked in hot alkali to increase the gelling strength. The cooked seaweed is washed, dried, and milled. For certain seaweed species such as E. spinosum, the cooking condition is much milder because it dissolves readily. In the refined process, the carrageenan is first dissolved by treating with a hot alkali solution and filtered to remove cell wall debris. The carrageenan is then precipitated from the clear solution either by isopropanol or by potassium chloride. In the mixed process, a hybrid technology in which seaweed is treated by various conditions of alkali and heating conditions as in the semi-refined process, but alcohol or high salt levels are used to inhibit dissolution at various steps of the manufacturing process. This process is often used on certain seaweed species and a balance of the cost benefits of semi-refined processing and allowing a wider range of seaweeds to serve as the raw materials.

All three of the conventional carrageenan extraction processes depend on hot alkali treatment that dissolve and separate carrageenan from the seaweed matrix. Although the semi-refined process does not require filtration after carrageenan is separated from the cellulose fiber matrix by a hot alkali treatment, this is because the natural fiber content for certain seaweed species suitable for this process is low. Therefore, the residual amount of cellulose fiber does not affect the functions and applications of carrageenan obtained by the semi-refined process. In sum, the sole purpose of the conventional carrageenan extraction methods is to obtain carrageenan as gelling/thickening agent. However, the hot alkali treatment may break down carrageenan and other valuable natural components or ingredients in seaweeds. For the refined process, which may be necessary for seaweed species with relatively high fiber content, the seaweed cellulose, which is a valuable source of dietary fiber, is discarded.

Disclosed herein is a novel approach to breaking down the cell wall of carrageenophyte red seaweed by a physical method without any hot alkali treatment, exposing carrageenan for direct use or for further refinement to improve gelling functions, and at the same time rendering the cellulose fiber being modified by various processes to improve food application qualities. The methods disclosed herein can be carried out without any hot alkali treatment to dissolve and separate carrageenan from cellulose. Thus, the carrageenan can be maintained in its native state of binding to cellulose without being degraded into small molecule fragments that are often associated with alkali treatment, especially alkali treatment under heat. Moreover, other natural beneficial components can be retained in the matrix. The methods disclosed herein are much more efficient and simplified compared with the conventional carrageenan extraction processes. The obtained products include a natural composite of carrageenan bound to cellulose fiber that retains both the gelling properties of carrageenan and the physiological function of dietary fibers.

The cell wall of certain red algae species is made primarily of a carrageenan and cellulose complex with other natural marine compositions. Cellulose is a polysaccharide polymer of β(1-4) linked D-glucose found in the cell wall of plants and algae. The cellulose polymer chains assemble together to form protofibrils, which further pack against each other to form higher-order cellulose fiber structure. The packing arrangement vary depending on the sources. For example, cellulose fiber from algae has different structural characteristics from that of terrestrial plants. However, cellulose fiber from closely related species generally share similar structure and property. The technology disclosed herein entails breaking down seaweed cell wall such that a natural composite material where carrageenan is in its native state bound to the cellulose can be obtained. The disclosed HPH process, when carried out at a normal temperature below 85° C. can retain the structure of carrageenan bound to cellulose within the carrageenan-cellulose composite materials. The carrageenan-cellulose composite materials can be processed into particle size less than or about 90 μm, wherein the cellulose fiber is less than or about 15 μm, and particle sizes of the carrageenan-cellulose composite materials and the cellulose fiber can be controlled by manufacturing processes based on application needs. The composite material particles have a general structure of carrageenan encapsulating or embedding the cellulose fiber although some particles have cellulose fiber exposed at the edge. The carrageenan located at the surface of the composite particles has functions and properties comparable to the carrageenan obtained by conventional processes. Therefore, the disclosed natural carrageenan-cellulose composite materials can replace carrageenan in many food applications. The insoluble cellulose fiber in the composite materials can be structurally modified by size reduction and by changing from fiber bundle naturally existing in seaweed plants into disrupted and dispersed fiber fragments. Therefore, the insoluble cellulose fiber has much increased surface area, better water binding and retention capacity and is stable in water after carrageenan is melted and dissociated from the cellulose fiber. These new structural features and functional enhancements make the carrageenan-cellulose composite materials disclosed herein a great source of dietary fiber. Surprisingly, the carrageenan-cellulose composite materials obtained by melting carrageenan and followed by HPH at a high temperature comprise cellulose self-assembled into a highly ordered structure wherein the cellulose fibers align along the same direction during the gelling and drying process, and upon rehydration, the fiber assembly can rapidly expand into an ordered array wherein the fiber fragments are dispersed but arranged parallelly along the fiber axis. This unusual property can have useful applications in food engineering using naturally available materials.

### II. Processes of Making the Natural Seaweed Composite Materials

The process in general includes the steps of treating the seaweed with high concentration of potassium chloride (KCl) under heat before subjecting the seaweed to high pressure homogenization (HPH). The raw materials used in this disclosure include fresh or dried red algae that are traditionally used to extract carrageenan, including Kappaphycus alvarezii, Eucheuma denticulatum, and the like, or a combination thereof. More generally, the raw material of the present invention comprises any carrageenan-containing red seaweeds (carrageenophytes) including but not limited to seaweed from the families of Gigartinaceae, Hypneaceae, Solieriaceae, Phyllophoraceae and Furcellariaceae and combinations thereof. Useful genera include Chondrus, Iridaea, Gigartina, Kappaphycus, Rhodoglossum, Hypnea, Eucheuma, Agarchiella, Gymnogongrus, Phyllophora, Ahnfeltia and Furcellaria and combinations thereof. Useful species include Eucheuma spinosum, Eucheuma cottonii, Chondrus Crispus, Gigartina skottsbergii, Kappaphycus alvarezii, Eucheuma denticulatum, and combinations thereof.

The bleaching step is optional to remove the natural color of the seaweed product, if desired. The seaweed is subjected to preliminary grinding including dry grinding or wet milling before or after KCl treatment. The KCl treatment is carried out before high pressure homogenization under heating at 80-100° C. for 1-6 hours, and the HPH can be carried out at low temperature between 0-85° C. without melting carrageenan off from its native plant matrix comprising the insoluble fiber. The HPH-treated seaweed is then dried and ground into the final carrageenan-cellulose composite materials having a desired particle size. If desired, the high pressure homogenization can be carried out at the elevated temperature such as 60-100° C. to melt the carrageenan, and the process further requires gelling by cooling in the presence of a low concentration of KCl. The specific details of the process may vary depending on the different starting raw materials and the desired features of the final product.

Process 1 Grinding Before Potassium Chloride Treatment

General Scheme:

Dried seaweed→washing and cleaning→bleaching→drying→pulverization→KCl treatment→high pressure homogenization→pressure filtering dehydration (or heating to above 60° C. to melt carrageenan and add KCl to cool and form a gel, then pressure filtering dehydration)→drying→pulverization to desired particle size

The process is as follows:

(1) The raw fresh or dried seaweed is cleaned by washing and removing impurities and debris;
(2) Optionally, the cleaned seaweed is treated with one or more bleaching agents (e.g., sodium hypochlorite, effective chlorine 0.1-0.5%) for 30 minutes to 2 hours, followed by a wash to remove the bleaching agent;
(3) The obtained seaweed is dried and pulverized to 80 mesh or more to obtain a crude seaweed powder;
(4) The crude seaweed powder is added to a potassium chloride solution of 5-20% (w/w), and treated at 80-100° C. for 1-6 hours, followed by pressure filtration or centrifugal dewatering;
(5) The KCl treated seaweed powder is dispersed evenly in water at a mass ratio of 1:20 to 1:100 (seaweed by dry weight to water) at 0-85° C., treated by high-pressure homogenizer at a pressure of 20-50 MPa, and the homogenized liquid is pressure filtered to remove water. For this approach, the goal is to carry out HPH and other processing steps under conditions and temperatures without melting and dissolving carrageenan from its natural seaweed matrix; alternatively, the seaweed powder is dispersed evenly in water at a mass ratio of 1:20 to 1:100 (seaweed by dry weight to water) at 60-100° C., treated by high-pressure homogenizer at a pressure of 20-50 MPa, and 0.1%-1.0% potassium chloride is added to the homogenized liquid and cooled to 0-40° C. to form a gel, which is dehydrated by pressure filtration;
(6) The solid component obtained by pressure filtration in step (5) is dried by hot air or other drying methods and pulverized to 80 mesh or more to obtain the final seaweed composite material.

Process 2 Grinding after Potassium Chloride Treatment

General Scheme:

Dried seaweed→washing and cleaning→KCl treatment→bleaching→washing→drying→pulverization→dispersing in water→high pressure homogenization→pressure filtering dehydration (or heating to above 60° C. to melt carrageenan and add KCl to cool and form a gel, then pressure filtering dehydration)→drying→pulverization to desired particle size

The process is as follows:

(1) The raw fresh or dried seaweed is cleaned by washing and removing impurities and debris;
(2) The cleaned seaweed is added to a potassium chloride solution of 5-20% (w/w), and treated at 80-100° C. for 1-6 hours, followed by washing to remove KCl;
(3) Optionally, the KCl-treated seaweed is treated with one or more bleaching agents (e.g., sodium hypochlorite, effective chlorine 0.1-0.5%) for 30 minutes to 2 hours, followed by a wash to remove the bleaching agent;
(4) The obtained seaweed is dried and pulverized to 80 mesh or more to obtain a crude seaweed powder;
(5) The seaweed powder is dispersed evenly in water at a mass ratio of 1:20 to 1:100 (seaweed by dry weight to water) at 0-85° C., treated by high-pressure homogenizer at a pressure of 20-50 MPa, and the homogenized liquid is pressure filtered to remove water; alternatively, the seaweed powder is dispersed evenly in water at a mass ratio of 1:20 to 1:100 (seaweed by dry weight to water) at 60-100° C., treated by high-pressure homogenizer at a pressure of 20-50 MPa, and 0.1%-1.0% potassium chloride is added to the homogenized liquid and cooled to 0-40° C. to form a gel, which is dehydrated by pressure filtration;
(6) The solid component obtained by pressure filtration in step (5) is dried by hot air or other drying methods and pulverized to 80 mesh or more to obtain the final seaweed composite material.

### Process 3 Wet Milling Before KCl Treatment

General Scheme:

Fresh or rehydrated seaweed→washing and cleaning→bleaching→KCl treatment→colloid milling→high pressure homogenization→pressure filtering dehydration (or heating to above 60° C. to melt carrageenan and add KCl to cool and form a gel, then pressure filtering dehydration)→drying→pulverization to desired particle size

The process is as follows:

(1) The raw fresh or dehydrated seaweed is cleaned by washing and removing impurities and debris;
(2) Optionally, the cleaned seaweed is treated with one or more bleaching agents (e.g., sodium hypochlorite, effective chlorine 0.1-0.5%) for 30 minutes to 2 hours, followed by a wash to remove the bleaching agent;
(3) The obtained seaweed is added to a potassium chloride solution of 5-20% (w/w), and treated at 80-100° C. for 1-6 hours, followed by washing to remove KCl;
(4) The KCl treated seaweed powder is dispersed in water and colloid milled to 80 mesh or more;
(5) The seaweed is dispersed evenly in water at a mass ratio of 1:20 to 1:100 (seaweed by dry weight to water) at 0-85° C., treated by high-pressure homogenizer at a pressure of 20-50 MPa, and the homogenized liquid is pressure filtered to remove water; alternatively, the seaweed powder is dispersed evenly in water at a mass ratio of 1:20 to 1:100 (seaweed by dry weight to water) at 60-100° C., treated by high-pressure homogenizer at a pressure of 20-50 MPa, and 0.1%-1.0% potassium chloride is added to the homogenized liquid and cooled to 0-40° C. to form a gel, which is dehydrated by pressure filtration;
(6) The solid component obtained by pressure filtration in step (5) is dried by hot air or other drying methods and pulverized to 80 mesh or more to obtain the final seaweed composite material.

Unlike traditional carrageenan extraction by hot alkali treatment, the technology disclosed herein pretreats the seaweed with a high concentration of a salt such as KCl (5-20% w/w) under high temperature (80-100° C.) for an extended period of time (1-6 hours), followed by high-pressure homogenization to obtain a carrageenan-cellulose fiber composite material. Without bound by theory, high concentration of KCl here may serve the role to stabilize carrageenan to prevent its dissolution loss at high temperature. It may also have other effects such as increasing the gelling strength of the isolated carrageenan-cellulose fiber composite materials. Carrageenan is present in the cell wall and intercellular matrix of the seaweed plant tissue together with the cellulose fiber. Heating at a high temperature may have a series of effects on the plant matrix structure, including the structures of a variety of bio-macromolecules and their assembly interactions, leading to a loosened structure that is amenable to further break down by mechanical processes such as high-pressure homogenization.

The concentration of KCl and the treatment time may vary depending on the type and state of the starting seaweed raw materials. In general, when the whole seaweed plant is used, the required KCl concentration is higher and the treatment time is longer. The concentration can be lower and the treatment time shorter after the seaweed has been pulverized (in dry form) or wet milled by colloid milling. The advantage of using whole seaweed is that it is easier to carry out washing between various steps of the processes, including removing the salt after the high concentration KCl treatment. The advantage of using pulverized or milled seaweed powder is that the high salt heating treatment could be carried out in relatively mild conditions (for example, lower KCl concentration and shorter heating time etc.). Therefore, the mild conditions help in preparing a natural carrageenan/cellulose composite containing additional natural compounds from seaweeds that may be lost or denatured under harsh conditions such as longer heating time.

Bleaching treatment is optional and can remove the natural colorants in seaweed to enhance the whiteness of the product. Bleaching is usually carried out at room temperature. The bleaching agent is one or more of hydrogen peroxide, sodium hypochlorite, chlorine dioxide, and the like. Preferably, a sodium hypochlorite solution is used as the bleaching solution, the effective chlorine concentration is about 0.1-0.5%, and the treatment time is about 30 minutes to 2 hours.

The bleached seaweed can be dried first, coarsely pulverized, and then added to 0-85° C. water or 60-100° C. water to carry out high pressure homogenization. Alternatively, after removal of the bleaching agent the wet seaweed can be directly added to 0-85° C. water or 60-100° C. water for wet milling using colloid milling, followed by high pressure homogenization. The material homogenized in 0-85° C. water can be dried by centrifugation or pressure filtration, and then dried and pulverized into the final product. The material homogenized in 60-100° C. water needs to be cooled to form a gel in the presence of a low concentration of KCl first, then dewatering by pressure filtration or freeze dry by lyophilization. The dried sample is pulverized into the final product.

The crude seaweed powder can be dispersed in water at 0-85° C. or at 60-100° C. and then subjected to HPH. Alternatively, the pretreated whole seaweed can be directly added to 0-85° C. or 60-100° C. water for wet milling using a colloid mill, followed by high pressure homogenization.

When homogenized at 0-85° C., the water-soluble polysaccharides including carrageenan remain in their natural unmelted state, and the resulting carrageenan-fiber composite material can be isolated by centrifugation or pressure filtration, dried and pulverized into final product. When homogenized in water at 60-100° C., the water-soluble polysaccharides including carrageenan are partially or mostly dissolved into water and separated from their natural seaweed plant matrix. The materials need to be cooled to form gel first, then dewatering by pressure filtration or freeze dry by lyophilization. The dried sample is pulverized into final product of desired particle size.

Colloid mill is a type of wet milling equipment that can reduce particle size by shearing and milling. High pressure homogenization can reduce particle size by high mechanical shearing forces. HPH can also loosen the structure of certain materials including insoluble plant fibers through entropic effect resulting from the dramatic drop of pressure associated with HPH. Natural cellulose fiber from plants including seaweeds are usually densely packed resulting in hard texture, poor mouthfeel and water binding properties. HPH treatment has been used to modify various plant derived fibers in a dissociated state to reduce particle size, disrupt fibrous structure and increase surface area, thereby to enhance their food application quality (e.g. water binding and retention capacity and viscosity and stability etc.). Unexpectedly, as it is disclosed herein, HPH can achieve a significant effect on breaking down seaweed cellulose fiber in the presence of naturally bound carrageenan. Thus, the disclosed process of making a natural carrageenan-cellulose composite material wherein the originally densely packed seaweed fiber bundles are broken into small fiber pieces even when the fiber is in a state associated with carrageenan and the association is maintained despite of the shearing force of HPH.

After the dry-grind seaweed powder is dispersed in water, or wet-milled seaweed sample is obtained, it is filtered by a cloth of 40 mesh or more, more preferably, 80-100 mesh or more, to prepare the sample for HPH. The HPH can be carried out in a single pass or multiple passes. For a single pass, the homogenization pressure is preferably from 20 to 100 MPa, more preferably from 30 to 60 MPa. For multiple passes, the homogenization pressure is preferably from 10 to 60 MPa, more preferably from 20 to 40 MPa.

The drying process can be carried out in many different ways and is not limited by any particular method. The final product is pulverized to 80 mesh or more, more preferably to 200 mesh or more. The actual particle size can be determined by specific applications.

Thus, in one embodiment, the disclosed technology entails breaking down seaweed cell wall at room temperature to expose carrageenan and to modify the structure of the cellulose fiber by reducing its size and/or increasing the exposed surface area to obtain a natural seaweed composite material. Although high pressure homogenization is used in working examples of this disclosure, the technology is not limited to HPH but rather including any methods that can break down seaweed cell wall while maintaining carrageenan in its native state bound to the cellulose. Alternatively, the HPH process is carried out in an elevated temperature to partially or completely melt carrageenan and then cool down in the presence of a low concentration of KCl to form a gel. Surprisingly, the carrageenan-cellulose composite materials obtained under these two different conditions have different structural and functional properties. The former results in a composite material comprising cellulose partially or entirely embedded or encapsulated by the carrageenan, while the latter results in a composite material comprising cellulose fiber capable of self-assembling into a fiber bundle and the composite material is highly absorbent or rapidly swells upon contact with a liquid such as water. The insoluble fiber in the composite material self-assembles into a highly ordered structure wherein the cellulose fibers align along the same direction during the gelling and drying process, and upon rehydration, the fiber assembly can rapidly expand into an ordered array wherein the fiber fragments are dispersed but arranged parallelly along the fiber axis. The manufacturing process may vary depending on the species of seaweeds and the desired properties of the final carrageenan-cellulose composite materials.

The following examples are intended to illustrate various embodiments of the invention. As such, the specific embodiments discussed are not to be construed as limitations on the scope of the invention. It will be apparent to one skilled in the art that various equivalents, changes, and modifications may be made without departing from the scope of invention, and it is understood that such equivalent embodiments are to be included herein.

### EXAMPLES

### Example 1: Preparation of a Seaweed Composite Material

This example describes preparation of a seaweed composite via Process 2 using Eucheuma denticulatum as the raw starting material. After washing and cleaning the seaweed in water to remove impurities and debris, the seaweed is pretreated with potassium chloride solution (20.0%, w/w) at a mass ratio of 1:15 (dry seaweed to KCl solution) for 4 hours at 90° C. The pre-treated seaweed was washed with water to neutral pH. Subsequently, the pre-treated seaweed was bleached with a sodium hypochlorite solution (effective chlorine 0.2%) for 1 hour at 25° C. The seaweed was then washed with water to remove the bleaching reagent and to bring back to neutral pH. The treated and bleached seaweed was dried and pulverized to at least 80 mesh to obtain a seaweed powder. A small sample was taken and pulverized to 180 mesh as Sample M, which served as an unhomogenized control.

The remaining seaweed powder was divided into two portions. A first portion of the obtained seaweed powder was dispersed in 30° C. water at a mass ratio of 1:50 (w/w dry weight of seaweed to water) and then homogenized by a high-pressure homogenizer at 25 MPa with one pass. The homogenized seaweed powder was subjected to pressure filtration dehydration and drying, and then pulverized to 180 mesh to obtain the final seaweed composite material, Sample L (normal temperature HPH).

A second portion of the obtained seaweed powder was dispersed evenly in water at a mass ratio of 1:50 (w/w dry weight of seaweed to water), boiled for 5 minutes, and then homogenized at 80° C. by a high-pressure homogenizer at 25 MPa for one pass. 0.2% (w/w) potassium chloride was added to the homogenized sample, and the homogenized sample was cooled to 20° C. to form a gel. The gel was dehydrated by pressure filtration, dried and pulverized to 180 mesh to obtain the final seaweed composite material, Sample B (high temperature HPH).

### Example 2: Analyses of Seaweed Composite Materials

The obtained seaweed composite materials, including the controls, were analyzed for their viscosity, gelling strength, stability, and particle size distribution, as described below.

Viscosity Measurement:

2.0 g of a seaweed composite material sample or a control sample was added to 198 g of deionized water, heated to boil, and cooled to 80° C. The viscosity of the sample was measured at 80° C. using a Brookfield viscometer, spindle #61 at 12 RPM.

Gelling Strength (g/Cm²) Determination:

0.2% (w/w) KCl was added to a stock solution of 1.5% (w/w) of each sample, the mixture was boiled for 5 minutes, and then cooled to 20° C. and kept for 15 hours before being analyzed for gelling strength using a texture analyzer (Stable Micro System, TA.XT.Plus Texture Analyser), probe: P/0.5; pressing speed: 1.5 mm/s; running speed: 1.0 mm/s; recovery speed: 1.5 mm/s. The pressing distance was 20 mm.

Stability of the Natural Seaweed Composite Material in Aqueous Solution:

60 ml of 0.5% (w/w) solution of Samples M, L, and B, respectively, was made in deionized water. The solution was heated up to boiling for 10 minutes with simultaneous stir bar agitation. The resulting solutions were placed into 50° C. water bath and left standing still. Aliquots of the solution were sampled into cuvettes with 3 times dilution at different time points. The light absorbance by the solution at different time points was measured at 600 nm using a DU® 640 spectrophotometer.

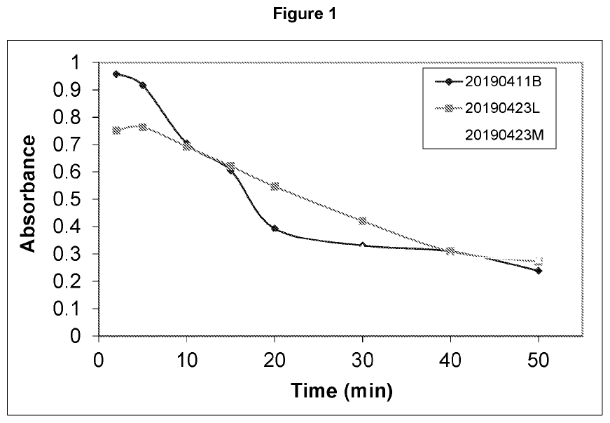

The purpose of these analyses was to evaluate whether high-pressure homogenization (HPH) affected the structure and function of the insoluble cellulose fiber. As shown in FIG. 1, high-pressure homogenization (HPH) treatment greatly enhanced the suspension stability of the insoluble fiber of the seaweed composite materials in both Sample L and Sample B as compared with the unhomogenized Sample M. This is reflected by the longer suspension time (higher optical absorbance at 600 nm) of the insoluble fiber in Sample L and Sample B than Sample M. Unexpectedly, Sample B seemed to be more stable than Sample L in the initial 20-minute time period, but Sample L was more stable at the later stage and over a longer period. Thus, the structural differences of Sample B (obtained by high temperature HPH) and Sample L (obtained by normal temperature HPH) demonstrated differences in their functions.

As shown in Table 1, the viscosity also increased significantly after HPH treatment, from 8 mPas·s for Sample M to 85 mPas·s for Sample B and 42 mPas·s for Sample L. Again, this was likely due to the structural changes of the insoluble fiber component of the seaweed composite material upon HPH treatment. Samples M, L and B had the same gelling strength, suggesting that the main effect of HPH was on the insoluble fiber component of the carrageenan-cellulose composite material.

TABLE 1
Properties of the Natural Seaweed Composite Materials

| | Sample M | Sample B (high | Sample L (normal |
|---|---|---|---|
| | (no HPH) | temperature HPH) | temperature HPH) |
| Viscosity (mPas · s) | 8 | 85 | 42 |
| Gelling strength | 600 | 600 | 600 |
| (g/cm²) | | | |

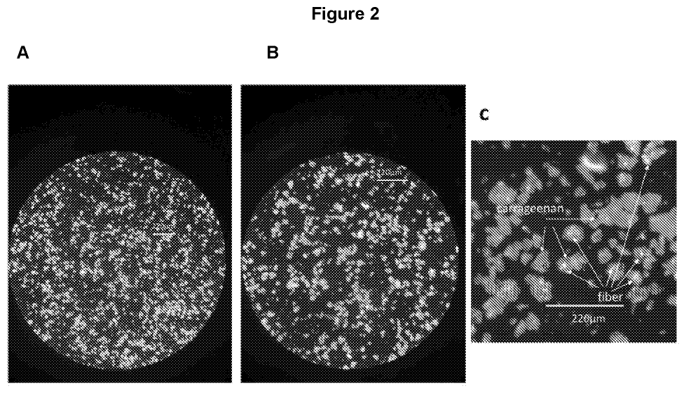

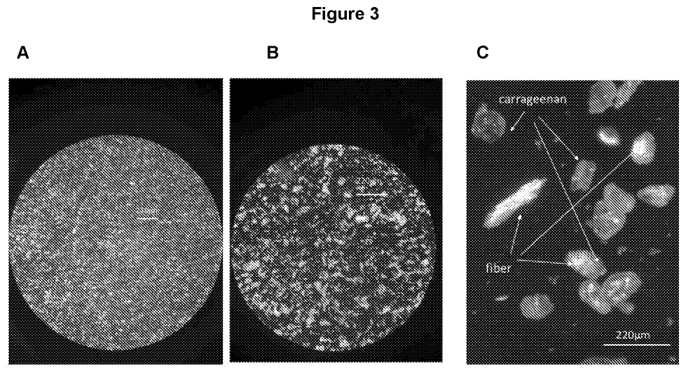

Imaging analyses of the seaweed composite material were performed to determine the structure of the material. The images of the seaweed composite material were taken with a Leica light microscope equipped with polarized filter (model MZ125). FIG. 2 and FIG. 3 show the imaging analyses of Sample L and Sample B, respectively. At a certain polarization angle, the crystalline insoluble cellulose fiber showed a lighter color, as seen in the center and the edge of many carrageenan-cellulose composite particles. The non-crystalline carrageenan showed as an opaque color at the outer region of the composite particle. The smallest division in the image was 11 μm, so most of the particles appeared to have a size around 40-50 μm.

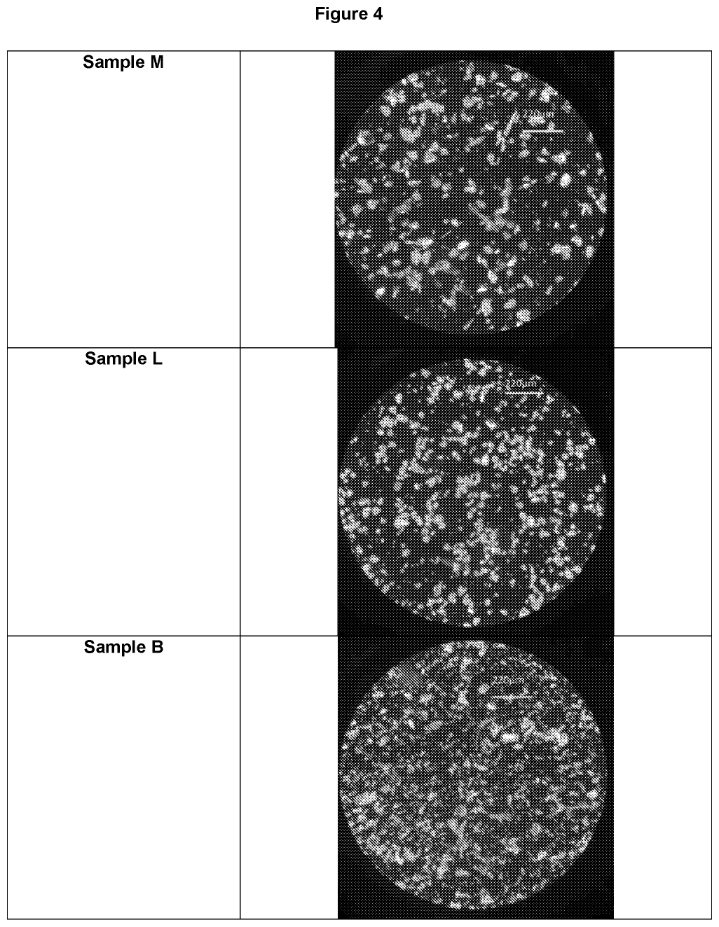

FIG. 4 shows the comparative imaging analysis of Samples M (no HPH control), L (normal temperature HPH), and B (high temperature HPH). As shown in FIG. 4, although all samples were pulverized by the same procedure, the particles from these three samples had very different structural features. Sample L contained evenly distributed, grainy particles, many of which had the insoluble cellulose fiber (displayed as the bright spots) entirely or partially encapsulated by carrageenan. By contrast, Sample B contained flakes with a wide distribution of particle sizes and shapes, most of them were thin pieces of carrageenan gel, while some others were almost entirely insoluble cellulose fiber particles. These observations suggest that Sample L and Sample B were structurally different although they were obtained by the same mechanical process of HPH. Sample L was obtained at normal temperature without melting the carrageenan to separate it from the insoluble cellulose fiber. Thus, Sample L maintained at least some aspects of the natural structure or assembly mechanisms between carrageenan and insoluble cellulose fiber. In contrast, the carrageenan was melted and dissociated from the insoluble cellulose during the high temperature HPH process to obtain Sample B and the gel was reformed after cooling and addition of 0.2% potassium chloride. During the cooling process, the insoluble cellulose fiber, given their high binding function and the tendency to self-associate, they may form fiber clusters, leading to a mixture of pulverized particles, with some made of mostly carrageenan gel, and some made of mostly cellulose fiber. The self-assembling of fiber bundles or clusters was not observed in Sample L because the carrageenan remained bound to the cellulose fiber during the low temperature HPH treatment. Although the exact particle size and shape may vary depending on the type of raw seaweeds used and processing details, comparison between Sample L and Sample B shows that the natural carrageenan-cellulose composite materials obtained by certain physical breaking down of seaweed cell wall is fundamentally different from materials obtained by processes involving melting carrageenan and re-gelling in terms of structure and function. One key difference is that when Sample B is added to water, the self-assembled fiber expands rapidly in an ordered array in solution. This is not observed in Sample L, where the fiber seems to be in the natural state associated with carrageenan, whereas the cellulose fiber in Sample B seems to undergo self-assembly after the carrageenan was melted off.

For the non-homogenized control Sample M, the particles, though seemed to be grainy similar to Sample L, contained a mixture of particles, some with more fiber than others. This probably is due to the fact that in the natural seaweed cell wall, the cellulose fibers are bundled together. Additionally, the particles in Sample M were not uniform in size and shape, with some particles retaining the large densely packed fiber bundles.

These structural differences have important functional implications. In Sample L, HPH results in the insoluble cellulose fibers evenly distributed and stabilized by the carrageenan naturally bound to the fibers. In Sample B, the insoluble cellulose fibers have the tendency to undergo large scale structure reorganization because the carrageenan is melted and dissociated from the fibers. This reorganization tendency is more pronounced when the fiber is physically and/or chemically processed to alter its structure to increase surface area, binding activity and viscosity. This is not only reflected by increased viscosity of the fiber, but more surprisingly, the fibers self-assembled into an ordered structure during the gelling and cooling process. Without bound by theory, it is possible that HPH-treated fiber may have an open structure that interact and bind the water soluble carrageenan molecules in the solution. During the gelling process, the fiber and the bound carrageenan molecules form an ordered array, and such structure is maintained in the drying process. Upon rehydration, the fiber assembly will expand due to the high water absorption activity of carrageenan, resulting an ordered fiber array reflecting the original self-assembled structure formed during the gelling and drying process. These unique features of the carrageenan-fiber composite materials generated by high temperature HPH treatment can have broad applications in food science such as controlling texture, flavor, and serving as carrier of macro- and micro nutrients. as well as in medical and material sciences.

Although the exact particle size and shape may vary depending on the type of raw seaweed materials used and processing conditions, comparison between Sample L and Sample B demonstrates that the natural carrageenan-cellulose composite materials obtained by the disclosed technology involving physical break-down of seaweed cell wall via processes such as HPH is fundamentally different from the materials obtained by conventional processes involving melting carrageenan and re-gelling. The natural seaweed composite materials disclosed herein has structural and functional features different from the seaweed materials obtained by conventional processes. For example, Sample L has structure of carrageenan bound to the insoluble fiber (mostly with the insoluble fiber encapsulated by the water soluble hydrocolloid carrageenan). As such Sample L has both the gelling function of carrageenan and the benefit of dietary fiber. The non-homogenized Sample M also contains natural fiber from seaweed. However, the structure of the particles in Sample M is different from that of the particles in Sample L: the former has the cellulose fiber distribute unevenly in the particles, with some (especially the large particles) have more cellulose fibers that retain the densely packed fiber bundle structure that gives rise the hard texture which limits their food applications. By contrast, the particles in Sample L are more uniform in size and shape, with insoluble cellulose fibers evenly distributed and stabilized by the carrageenan naturally bound to the fibers, and the fiber has been structural modified by HPH with reduced size and altered spatial organization.

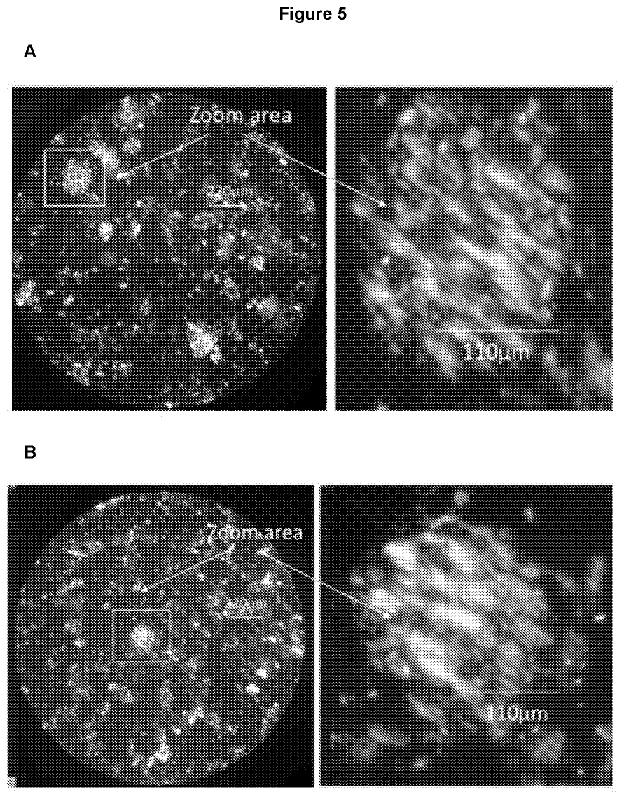

Comparative imaging analysis of cellulose fiber in different samples was performed to further explore the structural features of the natural seaweed composite materials disclosed herein. As shown in FIG. 5, the cellulose fiber maintained its naturally assembled structure in the non-homogenized Sample M, with multiple fiber strands aligned roughly in the same direction (see the zoom-in images). Such structures seemed to be largely maintained during the boiling (FIG. 5A) and gelling (FIG. 5B) processes.

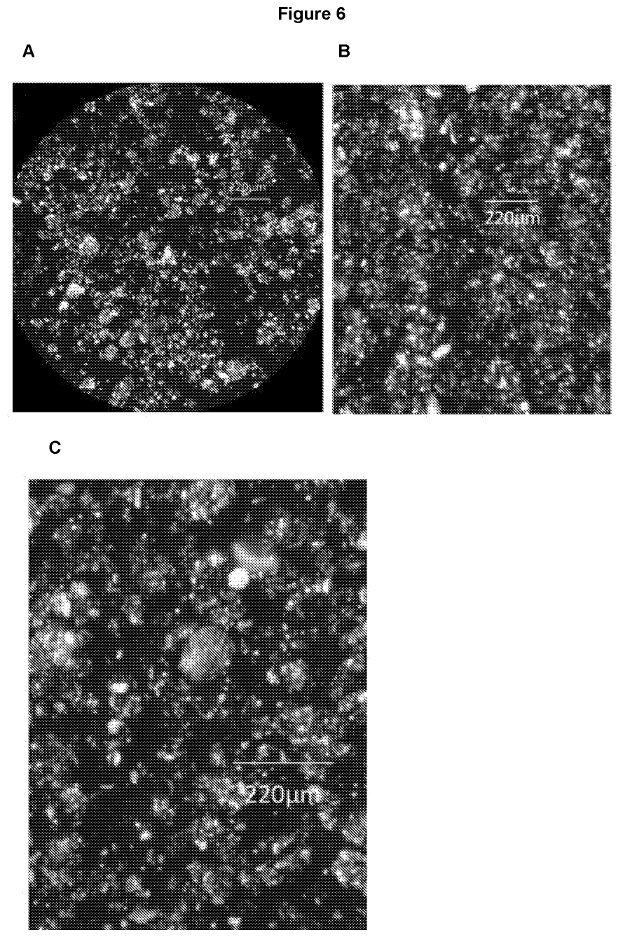

FIG. 6 shows that the cellulose fiber structures in Sample L were largely disrupted by the high-pressure homogenization (HPH) treatment. Although some residual fiber structures were seen in certain regions of the sample, the insoluble fiber in the seaweed composite material was disrupted and structurally altered while the insoluble fiber remained bound to the carrageenan. The degree of structural modification on the insoluble fiber may be optimized by the HPH parameters such as pressure, aperture, and number of passes. Unexpectedly, a natural carrageenan-cellulose composite material was prepared in which the insoluble cellulose fiber was structurally modified while remaining bound to carrageenan. All three samples showed that the fiber structure was disrupted and disorganized.

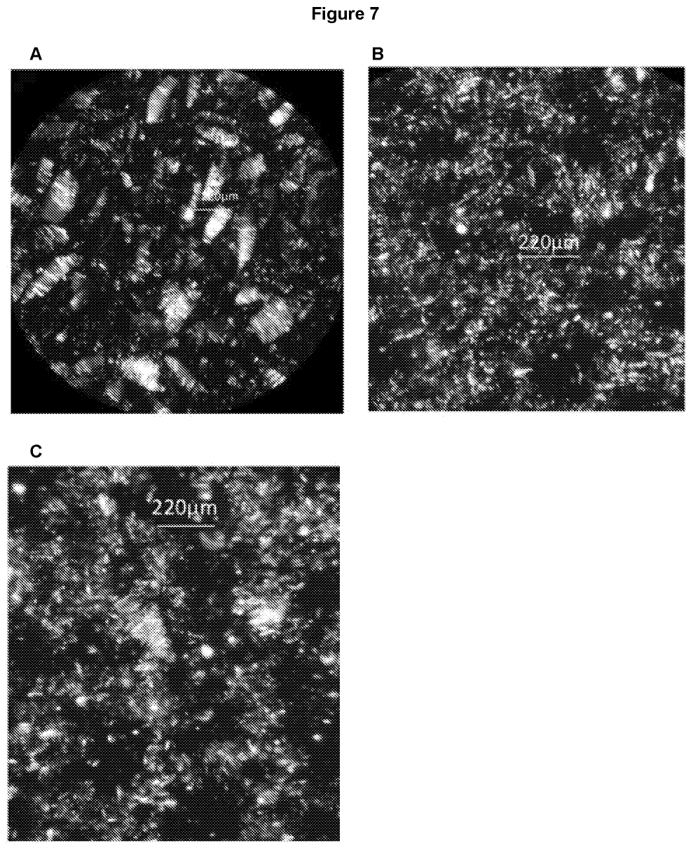

As shown in FIG. 7A, when Sample B was added to deionized water, the particles absorbed water and swelled rapidly. The insoluble fiber encapsulated within the composite material particles expanded as a long stretch of regularly aligned fiber bundles. It was demonstrated that the insoluble fiber had the tendency to re-associate during the cooling process when carrageenan was melted off during high temperature HPH treatment. Sample B was prepared by boiling the crude seaweed powder to melt and dissolve carrageenan and then break up the fiber by HPH. During the cooling process, the insoluble fiber pieces appeared to re-assemble into a structure that was buried or embedded within the carrageenan gel after potassium chloride was added. Surprisingly, the trapped fiber structure self-assembled into a regularly aligned fiber bundle upon rehydration of the seaweed composite material of Sample B. Boiling was able to disrupt this structure (FIG. 7B). As shown in the FIG. 7C, after adding 0.2% potassium chloride to induce the gelling process, a nucleation of the self-assembling process by the insoluble fiber started to form in the middle of the gel. These observations suggest that Sample B, which was obtained by HPH at a high temperature and subsequent cooling and gelling, was structurally different from Sample L, which was obtained by normal temperature HPH without melting carrageenan.

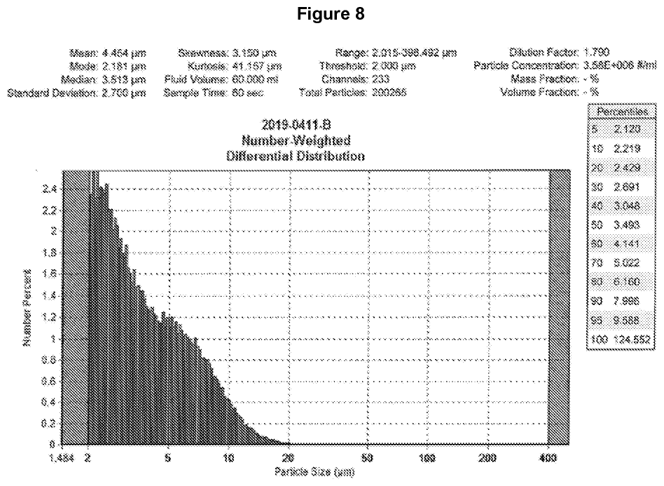

A particle size analysis was performed to assess the dimension of the insoluble fiber in the composite carrageenan-fiber materials. As an initial step, the carrageenan has to be melted by boiling, and therefore, Sample B was used for this analysis. The particle size analysis was done using the Particle Sizing Systems Accusizer (Model 780 AD, range 1-1000 μm) with the Extinction mode. Sample B was suspended in water at 1% (w/w) and boiled for 5 minutes to dissolve the water-soluble carrageenan before particle size analysis. FIG. 8 shows the particle size distribution of the insoluble fiber in Sample B.

Table 2 below shows a summary of the particle size analysis of the insoluble fiber in the carrageenan-composite materials.

TABLE 2
Particle Size Analysis

| | CUMULATIVE NUMBER | | | |
|---|---|---|---|---|
| | % LESS THAN | | | |
| | INDICATED SIZE | | | NUMBER |
| | D[n, 0.10] | D[n, 0.50] | D[n, 0.90] | WEIGHTED |
| SAMPLE ID | (μm) | (μm) | (μm) | MEAN |
| 2019-0411-B | 2.22 | 3.49 | 8.00 | 4.45 |

1. A natural seaweed composite material comprising one or more insoluble fibers and carrageenan, wherein the carrageenan is associated with the insoluble fiber.

2. The natural seaweed composite material of claim 1, wherein the insoluble fiber comprises cellulose and insoluble hemicellulose.

3. The natural seaweed composite material of claim 1, wherein the carrageenan is bound to the surface of the insoluble fiber.

4. The natural seaweed composite material of claim 1, wherein the insoluble fiber is partially or entirely encapsulated by the carrageenan.

5. The natural seaweed composite material of claim 1, wherein the insoluble fiber is partially or entirely embedded within the carrageenan.

6. The natural seaweed composite material of claim 1, wherein the natural seaweed composite material is obtained from red algae.

7. The natural seaweed composite material of claim 1, wherein the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm.

8. The natural seaweed composite material of claim 1, wherein the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.

9. A highly absorbent natural seaweed composite material comprising one or more insoluble fibers and carrageenan, wherein the insoluble fiber is capable of self-assembly into a highly ordered structure such that the cellulose fibers align along the same direction during the gelling and drying process, and upon rehydration, the fiber assembly rapidly expands into an ordered array wherein the fiber fragments are dispersed but arranged parallelly along the fiber axis.

10. A method of making a natural seaweed composite material from red algae, comprising the steps of:
treating the fresh or dried seaweed with potassium chloride at a high concentration under heat,
subjecting the ground seaweed to high pressure homogenization (HPH), and
drying and grinding the homogenized seaweed powder to a desired particle size to obtain the natural seaweed composite material.

11. The method of claim 10, further comprising grinding the seaweed by wet milling or dry grinding before or after the treatment by potassium chloride.

12. The method of claim 10, wherein the HPH is carried out at a temperature of between 0° C. and 85° C.

13. The method of claim 10, wherein the HPH is carried out at a temperature of between 60° C. and 100° C.

14. The method of claim 10, wherein the seaweed is washed and/or cleaned to remove debris before the salt treatment.

15. The method of claim 10, the seaweed is bleached by one or more bleaching agents before HPH.

16. A natural seaweed composite material produced by the method of claim 10.

17. A natural seaweed composite material produced by the method of claim 12, comprising one or more insoluble fibers and carrageenan, wherein the carrageenan is associated with the insoluble fiber.

18. The natural seaweed composite material of claim 17, wherein the insoluble fiber comprises cellulose and insoluble hemicelluloses.

19. The natural seaweed composite material of claim 17, wherein the insoluble fiber is associated with carrageenan in a manner similar to the association in the natural state in seaweed before processing.

20. The natural seaweed composite material of claim 17, wherein the carrageenan is bound to the surface of the insoluble fiber such as cellulose of the natural seaweed composite material.

21. The natural seaweed composite material of claim 17, wherein the insoluble fiber is entirely or partially embedded within the carrageenan.

22. The natural seaweed composite material of claim 17, wherein the insoluble fiber is partially or entirely encapsulated by carrageenan.

23. The natural seaweed composite material of claim 17, wherein the natural seaweed composite material has a particle size of less than or about 100 μm, less than or about 90 μm, less than or about 80 μm, less than or about 70 μm, less than or about 60 μm, less than or about 50 μm, less than or about 40 μm, less than or about 30 μm, less than or about 20 μm, less than or about 10 μm, less than or about 5 μm, less than or about 4 μm, less than or about 3 μm, less than or about 2 μm, or less than or about 1 μm.

24. The natural seaweed composite material of claim 17, wherein the natural seaweed composite material has a particle size of between 0.1 μm and 100 μm, between 1 μm and 100 μm, between 10 μm and 90 μm, between 20 μm and 80 μm between 30 μm and 70 μm, between 40 μm and 60 μm, between 0.5 μm and 20 μm, between 1 μm and 15 μm, between 2 μm and 10 μm, between 3 μm and 8 μm, between 4 μm and 7 μm, or between 5 μm and 6 μm.

25. A natural seaweed composite material produced by the method of claim 13, comprising one or more insoluble fibers and carrageenan, wherein the insoluble fiber is capable of self-assembly into a highly ordered structure such that the cellulose fibers align along the same direction during the gelling and drying process, and upon rehydration, the fiber assembly rapidly expands into an ordered array wherein the fiber fragments are dispersed but arranged parallelly along the fiber axis.
